(19) United States
(12) Patent Application Publication
(10) Pub. No.: US 2005/0206262 A1
(43) Pub. Date: Sep. 22, 2005

(54) Permanent magnet array and magnet holder for flywheel motor/generator

(76) Inventors: Michael Kim, Pleasanton, CA (US); Donald Bender, San Ramon, CA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/909,722

(22) Filed: Aug. 2, 2004

Related U.S. Application Data
(63) Continuation of application No. 10/660,185, filed on Sep. 11, 2003, now abandoned.
Application No. 10/660,185 is a continuation of application No. 10/272,839, filed on Oct. 17, 2002, now abandoned.
Application No. 10/272,839 is a continuation of application No. 09/649,144, filed on Aug. 25, 2000, now abandoned.
(60) Provisional application No. 60/151,236, filed on Aug. 27, 1999.
(60) Provisional application No. 60/152,453, filed on Sep. 3, 1999.

(51) Int. Cl. H02K 21/12; H02K 1/27

(52) U.S. Cl. 310/156.43; 310/156.08; 310/156.28

(57) ABSTRACT

The invention involves a flywheel motor/generator having a holder to maintain the permanent magnets in a circular array on the rotor. Unique aspects of the invention include the magnet shapes that are used, the liner/retainer configuration used to secure the magnets, and the construction of the rotor in the immediate vicinity of the magnets. The principal functions of the design are 1) managing stresses in the rotor and the magnets at high speed when centrifugal acceleration can exceed 100,000 g's, and 2) securing the magnets when the assembly is at rest when magnets that are not properly secured can reposition themselves in deleterious ways through mutual attraction or repulsion. Keying features are also provided on the ends of the magnets to aid in assembly of the rotor and to maintain the magnets in the proper orientation.

This application claims the benefit of U.S. Provisional Application No. 60/151,236, filed Aug. 27, 1999, entitled Permanent Magnet Array And Holder For Flywheel Motor/Generator and U.S. Provisional Application No. 60/152,453, filed Sep. 3, 1999, entitled Permanent Magnet Array And Holder For Flywheel Motor/Generator.

### BACKGROUND OF THE INVENTION

The present invention pertains to the design and construction of a permanent magnet electrical machine built into a flywheel rotor. The electrical machine functions equally well as a motor or a generator and is referred to as a flywheel motor/generator.

The magnets are located around the bore of a cylinder made from composite material. The magnets working together create a field within the rotor bore that excites stator windings when the cylinder is rotating. This rotation of the magnetic field with respect to the stator windings comprises the motor/generator function of converting electrical energy to kinetic energy and vice versa.

An example of the state of the art of this type of machine is described in U.S. Pat. No. 5,705,902, incorporated herein by reference. A cross section of the Halbach magnet array of the type used in this patent is shown here in FIG. 1A. The major axis of each magnet segment is parallel to the centerline and axis of rotation of the rotor.

Several difficulties are encountered in the implementation of this magnet configuration.

1. High centrifugal forces result in high contact pressure between the magnet and the rotor.

2. Expansion of the rotor results in high circumferential strains on the magnet face contacting the inner bore of the rotor. The strain can be high enough to fracture the magnet material.

3. Expansion of the rotor results in the concentration of rotor stress both between magnet segments and directly ‘underneath’ (radially outward from the center of) each segment.

4. If a simple cylindrical rotor bore is used, the magnet segments must use a shape with the direction of magnetic polarization varying from segment to segment. Except for the special case where cylindrical bar segments are used, it is not possible to use a magnet segment of a single design and this results in higher manufacturing cost.

### SUMMARY OF THE INVENTION

Some unique aspects of the invention are the magnet shapes that are used, the liner/retainer configuration used to secure the magnets, and the construction of the rotor in the immediate vicinity of the magnets. The principal functions of the design are (1) managing stresses in the rotor and the magnets at high speed when centrifugal acceleration can exceed 100,000 g's and (2) securing the magnets when the assembly is at rest, when magnets that are not properly secured can reposition themselves in deleterious ways through mutual attraction or repulsion.

Square magnets that do not entirely fill the annular magnet region are the preferred embodiment although other bar shapes may be used. When square cross section magnets are used, the magnets are supported directly by the bore of the rotor. The arrays may be built to any useful axial length by stacking sets of segments where the sets are identical in cross section. Each bar in the cross section may comprise a number of shorter segments.

### BRIEF DESCRIPTION OF THE DRAWINGS

FIG. 1A is a top plan view showing arcuate magnet segments of the prior art forming a dipole Halbach Array.

FIG. 1B is a top plan view showing 24 square bar magnet segments forming a multiple pole Halbach Array.

FIG. 1C is a top plan view showing 16 square bar magnet segments forming a multiple pole Halbach Array.

FIG. 2 is a top plan view showing square magnets and a magnet holder inside a polygonal bore.

FIG. 3 is a top plan view showing square magnets and a magnet holder inside a round bore.

FIG. 4 is a top plan view showing cylindrical magnets forming a dipole Halbach Array.

FIG. 5 is a top plan view showing cylindrical magnets, a magnet retainer, and a liner inside a rotor bore.

FIG. 6 is a top plan view showing a first alternative embodiment to FIG. 5.

FIG. 7 is a top plan view showing a second alternative embodiment to FIG. 5.

FIG. 8 is a top plan view showing a third alternative embodiment to FIG. 5.

FIG. 9 is a top plan view showing a fourth alternative embodiment to FIG. 5.

FIG. 10 is a top plan view showing a magnet with anti-rotation flats.

FIG. 11A is a perspective view showing step features on each end of a magnet segment.

FIG. 11B is a perspective view showing groove features on each end of a magnet segment.

### DETAILED DESCRIPTION OF THE PREFERRED EMBODIMENTS

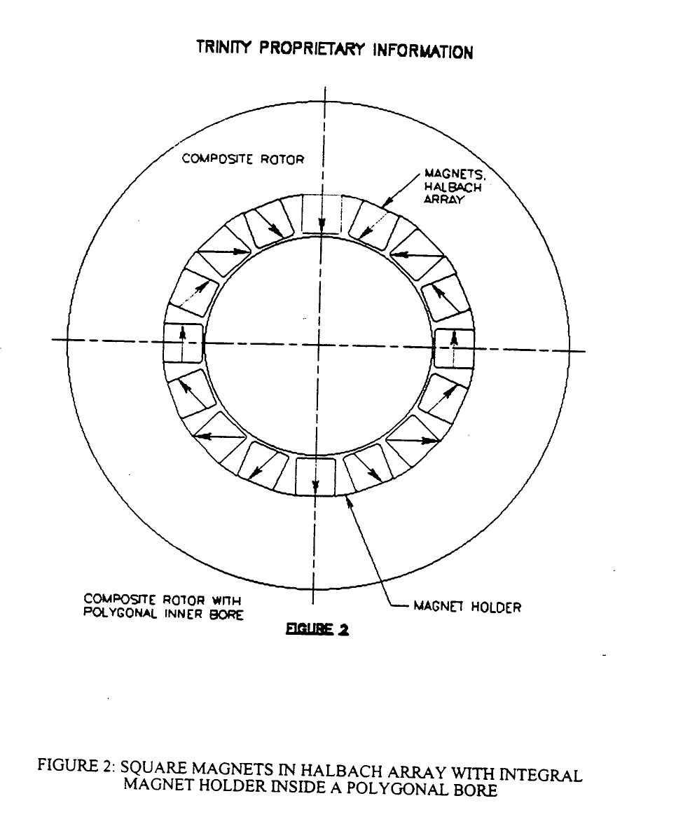

The flywheel rotor design is shown in cross section in FIG. 2. This configuration shows 16 square magnets, symmetrically positioned about the rotor axis with uniform spacing. The configuration shows that bars with just three distinctly different polarizations are sufficient to fully populate the 16 segment array. This combination produces a uniform dipole field. Surrounding the magnet array is a composite rotor, which may be wet-filament wound or wound using pre-preg tape or tow. The magnet holder encapsulates and holds the magnets in place. The holder is thin but it is strong enough to maintain the magnet segments in proper position. The holder also keeps the magnets from rotating. The holder keeps broken magnet fragments from escaping into the flywheel surroundings. The holder should be stiff and low in mass.

Placement of permanent magnets into an assembly can be difficult since repulsive and attractive contact pressure can be over 80 psi. Assembly of arrays of high field magnets typically requires dedicated tooling to maintain control of segment position as they are brought into close proximity. The magnet holder used in this invention also locates the components during assembly eliminating the need for dedicated tooling and simplifying the magnet assembly process.

Rotor construction here uses stronger, stiffer composite material at the mating surface to the magnets. This contrasts from the conventional practice of using low modulus materials at the bore of the rotor to reduce radial tensile stresses in thick rotors. The stiffer composite material at the bore reduces the radial growth of the rotor thereby reducing the strain on the magnets. Since high modulus material is typically stronger than low modulus material, use of high modulus material at the bore of the rotor strengthens the rotor were the stresses are highest. To minimize the number of unique magnet parts and to integrate a non-rotating index feature, square magnet design is used to produce the dipole magnetic field.

The wound composite rotor typically has very high hoop strength and stiffness. Because the holder is supported by the rotor, the holder can be made of much weaker material. The holder can be fabricated from conventional plastic (such as nylon), or reinforced thermoplastic (such as glass filled polycarbonate), or compression molded carbon fiber and epoxy. The choice of an optimum material depends on details of the holder configuration. The holder may be machined from solid stock or may be produced by compression molding or resin transfer molding.

FIG. 2 also shows a composite rotor with polygonal inner bore. The flat sections of the rotor maintain the magnet's position. The rotor can be wound with the polygonal inner bore by using a polygonal winding mandrel.

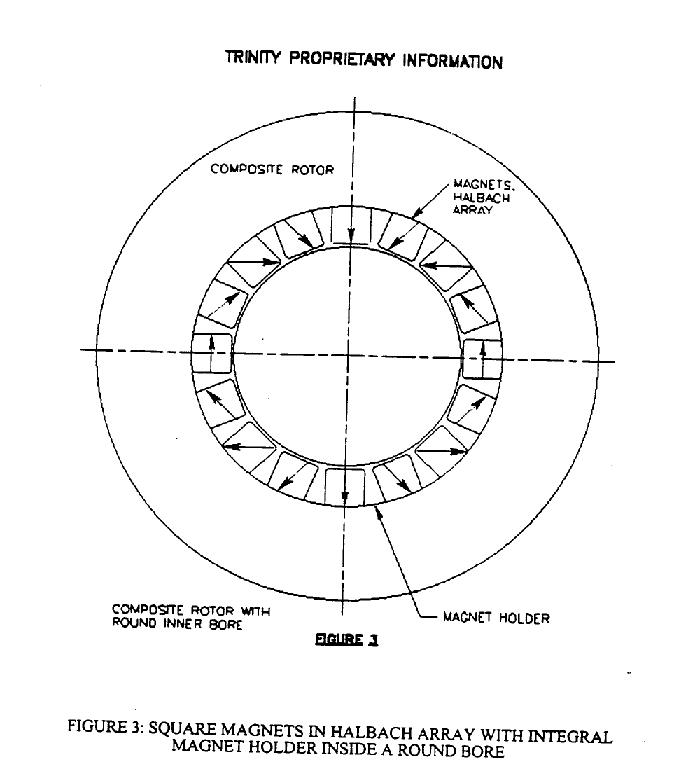

Certain variation to the basic configuration is practical as shown in FIG. 3:

Basic differences are:

Holder: The holder geometry is essentially the same whether the rotor has a cylindrical bore (as shown in FIG. 3) or a polygonal bore (as shown in FIG. 2). The portion of the holder that abuts the rotor is contoured to match the surface of the rotor.

Magnet shape: The magnets maintain the simple square bars configuration with one modification. A round radius is added to the square magnet shape. The radius on the magnet matches the radius of the inner bore. An advantage of this configuration is the lowering of the stress concentration present in the polygonal bore. The magnets are made from high field material such as NdFeB or Samarium Colbalt or are ceramic. They may be machined and ground to final shape from anisotropic stock or they may be sintered and compressed to near net shape with a higher degree of isotropy.

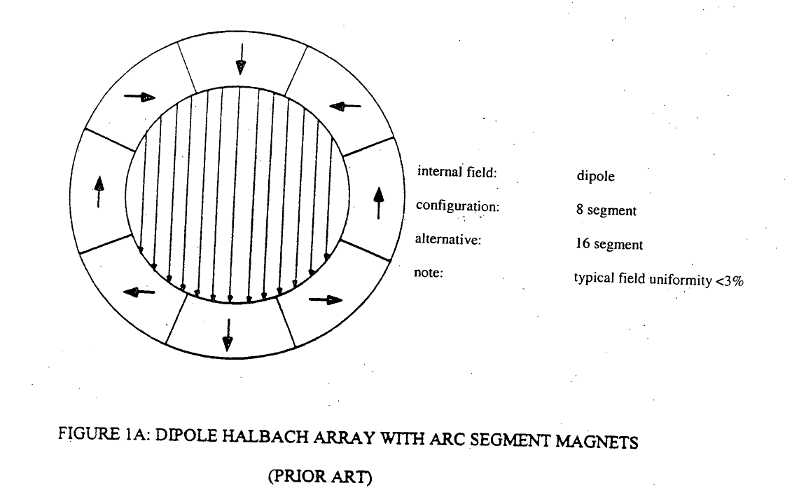

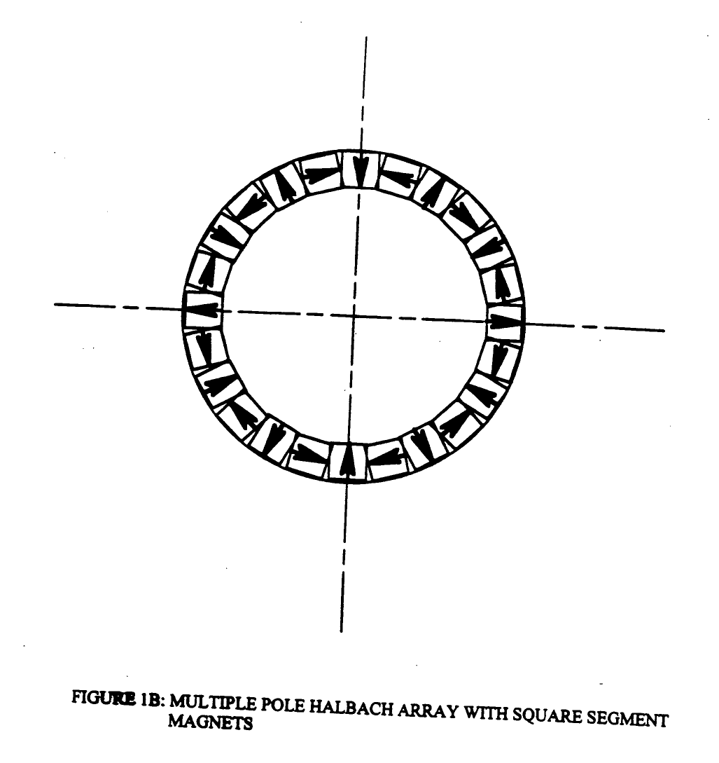

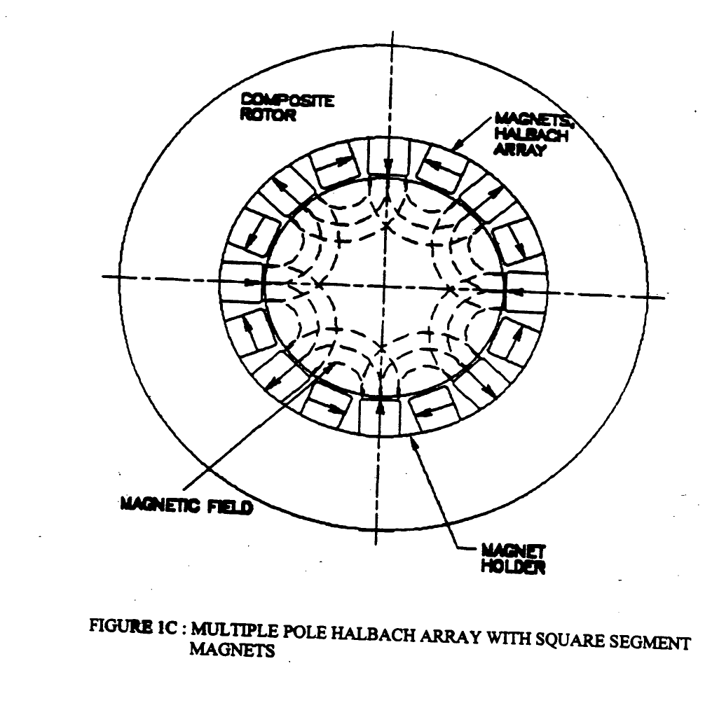

The holder configuration is also useful for higher order permanent magnet arrays such as the 12 pole, 24 magnet array shown in FIG. 1B. In this case, only one type of bar is required: a bar of square cross section that is transversely polarized.

Alternate Configurations

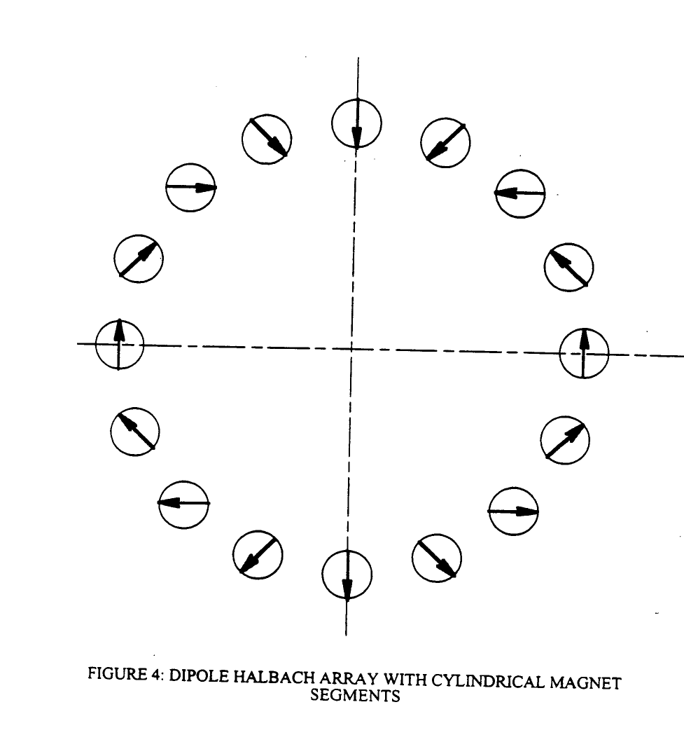

Many variations of the magnet and liner shape are practical. Cylindrical bars shown in FIG. 4 offer the greatest flexibility. Useful variations for configuring the cylindrical bar and liner are listed as follows:

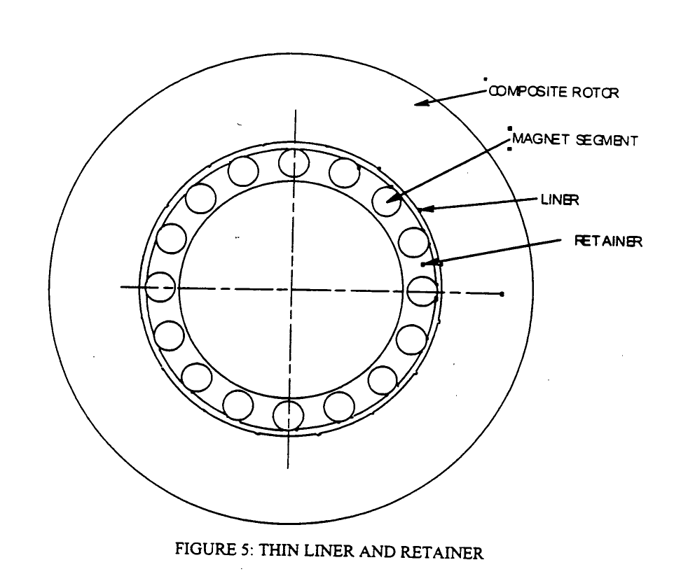

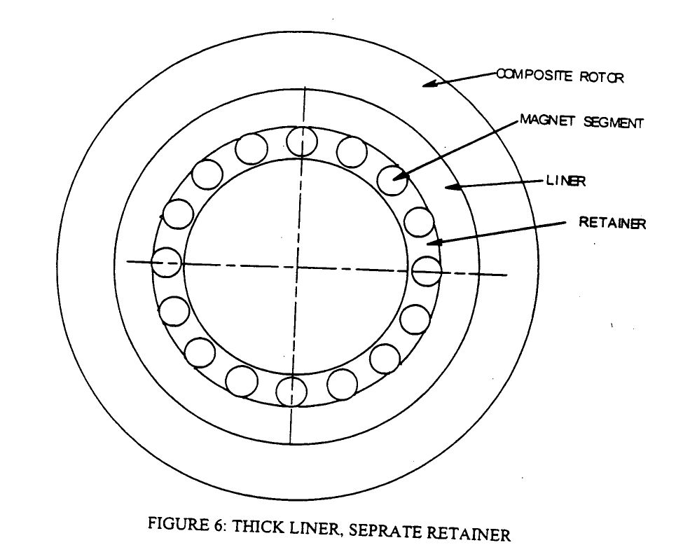

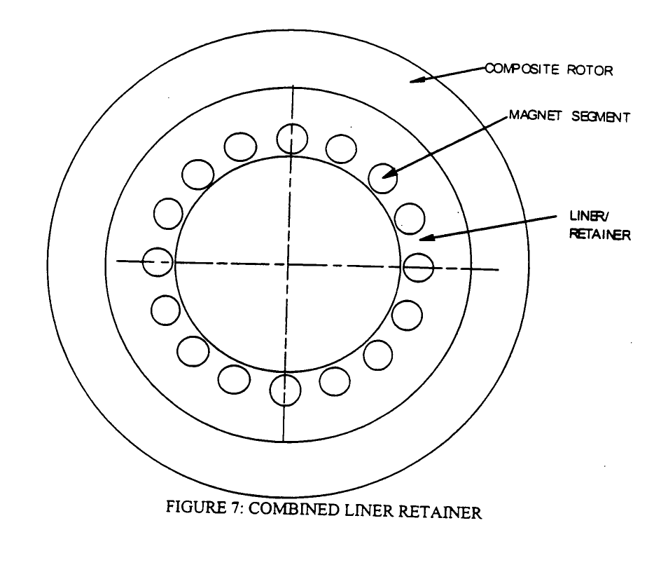

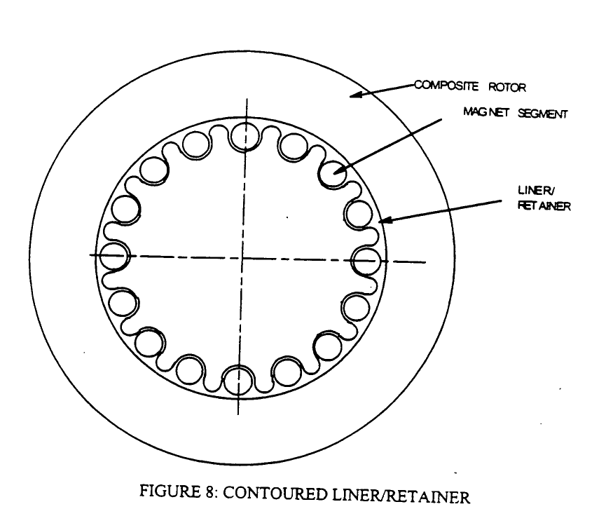

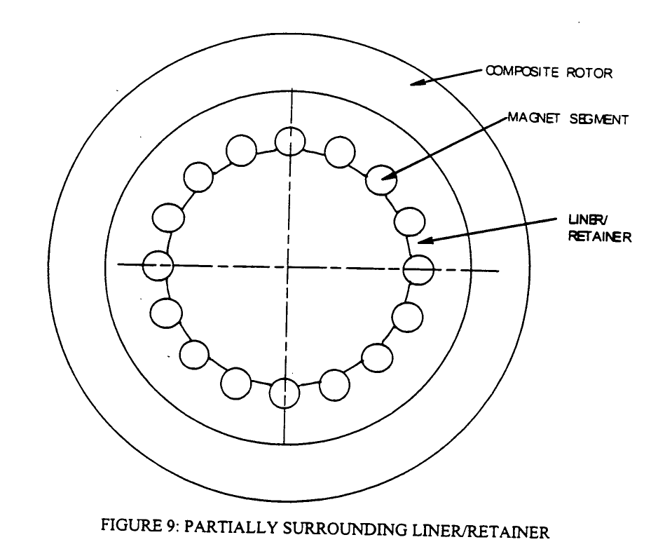

Liner. The liner geometry has a range of practical alternatives that achieve the same objective. One variable is the extent to which the liner surrounds the magnets. The liner may have a shallow recess (FIG. 5 and 6), may partially surround the magnet (FIG. 9), or may fully surround the magnet (FIGS. 7 and 8). If the liner surrounds the magnets sufficiently, no additional retainer is required. Material that is not structurally useful may be removed from the liner resulting in a contoured shape as shown in FIG. 8.

Magnet shape (variations of rounds bars). For this set of alternatives to square bars or square bars with an outboard radius, the magnets will be round bars with many possible geometric features. A criteria for the selection of a non-square bar magnet shape is that the bars are all of the same design. The only difference being that they are clocked differently during assembly to orient the magnetic field as necessary for performance of the flywheel motor/generator. The following shapes may be used: cylindrical, polygonal, and round with a locating features on the sides or end.

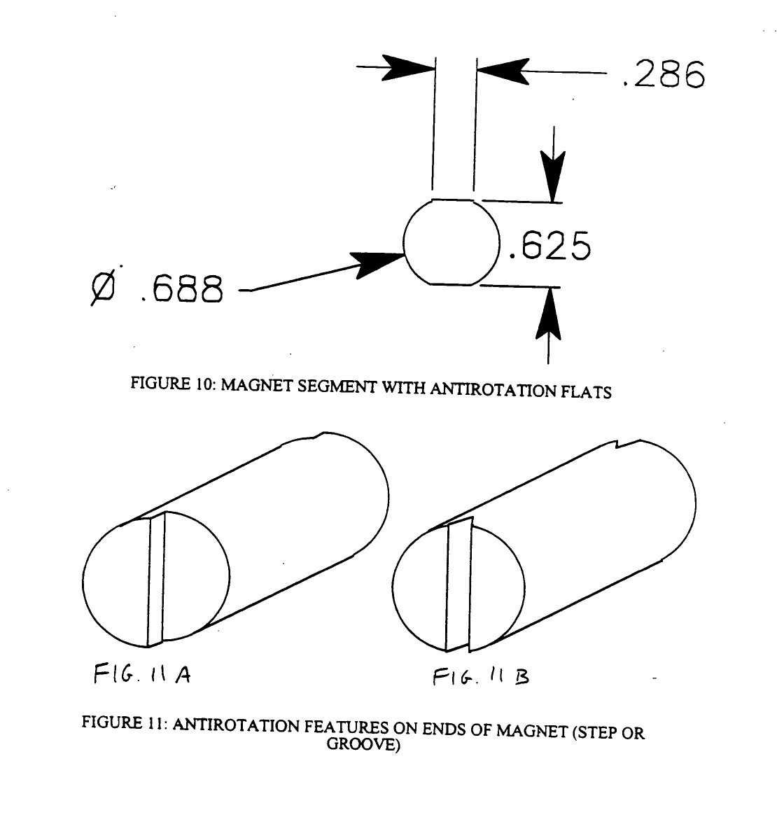

The magnets have antirotation features to hold the magnets securely and in the proper orientation during assembly. One example of such a feature is antirotation flats as shown in FIG. 10. A magnet of this shape would have corresponding flats fabricated into the liner and retainer. The particular configuration shown in FIG. 10 uses flats of the same width, but flats of different width could alternatively be used. This would permit a configuration that would allow assembly of each magnet into the liner and retainer with no ambiguity regarding orientation, eliminating assembly errors. A further derivative of this concept is to use a polygon with six or more sides.

An alternative to placing antirotation features on the sides of the magnets is to place antirotation features on the ends of each magnet. The preferred configuration is to use either a step or a groove as shown in FIGS. 11A and 11B, respectively. These features mate with corresponding features in the magnet holder. Each magnet in the circular array can be of a single piece, or can comprise several magnet segments stacked end-to-end and axially aligned. When the steps shown in FIG. 11A are used, the step on an end of one magnet interlocks with the step on an adjacent magnet to keep the magnets aligned in the proper direction. When the grooves shown in FIG. 11B are used, dowels or bars, equal or shorter in length than the diameter of the magnets, are placed between the magnets to engage and align the two adjacent grooves.

The following is a summary of features of the preferred embodiments:

(1) The invention is an array of magnets made from high field material such as NdFeB or Samarium Cobalt or ceramic where the magnets are arranged in an annulus and secured by a non-magnetic holder.

(2) The magnets are bars with the major axis of the bar parallel to the major axis of the rotor and the bars may be made up of shorter segments placed end to end.

(3) The bars bear directly on the composite surface or bear on a liner surface.

(4) Where the bars bear directly on the bore of the rotor, the rotor is manufactured with high modulus composite along the bore which makes the rotor stronger at this high stress point and minimizes the circumferential tensile strain imposed by the rotor on the magnet and allows the rotor to operate at higher speed than would be attained without this feature. The bore of the rotor may be wet filament wound or manufactured using pre-preg tape or tow.

(5) The bars are secured against rotation by the non-magnetic holder or by end features in the bars.

(6) The field produced by the magnet array is a dipole field or a field with a larger number of poles where the number of poles may be equal to but no greater than half the number of magnet bars.

(7) The bars may be substantially square in cross section or may be round or they may be polygonal.

(8) Square cross section bars may have flat sides or the surface of the bar contacting the rotor may be curved to precisely mate with the cylindrical bore of the composite rotor.

(9) Where square bars are used, the rotor may be wound on a polygonal mandrel to produce flat internal facets that locate and support the magnets.

(10) Round bars may have flats to engage with mating features in the holder to ensure proper alignment during assembly and to prevent rotation during operation.

(11) An array of 16 square bars will produce a uniform dipole field where there are three types of unique polarization direction for the bars and several (e.g. 4, 4, or 8) bars of each of these three polarization are used in the assembly.

(12) Each of the round bars in an array of round bars may have the same configuration.

(13) The magnet holder may be made from nylon, polycarbonate, or any strong plastic or and may be partially filled with carbon or glass fiber for additional strength or aluminum may be used.

(14) The magnet holder may be machined from solid stock or may be molded.

(15) The magnet holder positions the segments during assembly eliminating the need for magnet assembly tooling.

1. A circular permanent magnet array comprising:
a plurality of elongate magnets each having a longitudinal axis, the magnets arranged around a common central axis of certain axis of rotation with the longitudinal axes located parallel to and radially offset from the axis of rotation; and
a nonmagnetic magnet holder for maintaining the magnets in a fixed position, the magnet holder being made of a material selected from the group consisting of conventional plastic, reinforced thermoplastic and compression molded fiber and epoxy.

2-26. (canceled)
